(19) United States
(12) Patent Application Publication
(10) Pub. No.: US 2022/0026887 A1
(43) Pub. Date: Jan. 27, 2022

(54) METHOD FOR OPTIMIZING AND/OR OPERATING A PRODUCTION PROCESS, A FEEDBACK METHOD FOR A PRODUCTION PROCESS, AND A PRODUCTION PLANT AND COMPUTER PROGRAM FOR PERFORMING THE METHOD

(71) Applicant: ENGEL AUSTRIA GmbH, Schwertberg (AT)

(72) Inventors: Georg PILLWEIN, Linz (AT); Johann VOGGENEDER, Mauthausen (AT); Friedrich Johannes KILIAN, Neuhofen (AT)

(21) Appl. No.: 17/369,471

(22) Filed: Jul. 7, 2021

(51) Int. Cl. G05B 19/418; G06N 20/00; G06K 9/62

(52) U.S. Cl. CPC G05B 19/41865; G05B 19/4183; G06K 9/6256; G06N 20/00; G05B 19/4188

(57) ABSTRACT

A method includes recording: a setting value of a setting quantity, a value of a process quantity, and/or a value of an indirect process quantity of the production process obtained from a value of a process quantity by a data recording unit. The method also includes establishing a calculated setting value and/or an electronic message by a computing unit by a set of rules. The input data of the set of rules includes the values recorded and/or a system configuration value of a system configuration quantity and/or classified values from the values. The method also includes deciding whether the calculated setting value should be adopted and/or the recommended action should be followed by a decision-making unit and/or the operator via the operator interface. The set of rules is created by a learning unit by a machine learning process employing training data from production plants and/or production machines.

The invention relates to a method for the optimisation and/or operation of at least one production process with the characteristics of the preamble of claim 1, as well as a feedback method with the characteristics of the preamble of claim 28. The invention also relates to a production plant in accordance with claim 32 with means for performing the method described in claim 1 and/or the feedback method from claim 28. In addition, the invention describes a computer program product in accordance with 33.

In the publication of this application, the word ‘method’ is used as a short form to describe the method of optimisation and/or operation of at least one production process. In particular, the word ‘method’ does not describe the feedback method. Similarly, the ‘set of rules’ is not be understood as a short form o ‘a set of feedback rules’.

By way of example, the production process can be a shaping process, in particular an injection moulding process. Production machines follow this terminology analogously. The production process can run continuously or cyclically.

Generally speaking, controlling a production process requires the input of a large number of setting quantities for process quantities. As, in the production process, this large number of quantities do influence each other strongly, finding an appropriate setting that leads to high-quality products, preserves resources and that does not damage the production plant is in general difficult to achieve, and can be accomplished manually by experienced operators only.

The state-of-the-art includes expert systems that assist the operator when setting up production processes. However, they are based on a limited range of data that is collected and prepared manually by experts. This means that the wide range of measuring data from sensors currently available is not used on a production plant.

Furthermore, the state-of-the-art uses a wide range of process data and/or setting data from a production machine for the machine learning of a set of rules instead of expert systems, with said set of rules being capable, for example, of predicting the quality of the product. By way of example, this makes it possible to test whether a defined setting on a production machine is appropriate. In addition, a machine-learned set of rules can be used to automatically determine monitoring limits. For example, this is implemented in U.S. Pat. No. 7,216,005 B2 by using neural networks. Optimisation of a process optimisation system based on simulations is disclosed in AT 519491 A1. However, the training of this set of rules typically refers to a single production machine.

It is also state-of-the-art to send a wide variety of data relating to the operator response and/or process data of a large number of production processes to a central computer network. Typically, this data is analysed in the plant and manually to help improve new generations of production machines and/or production plants. However, the setting of the existing production plant is not affected by this.

The aim of this invention is to avoid the disadvantages of the state-of-the-art. In particular, the aim is to create an improved method, an improved feedback method, an improved production plant and an improved computer program product.

According to this invention, this task is resolved by a method with the characteristics of claim 1, a feedback method in accordance with claim 28, a production plant in accordance with claim 32 and a computer program product in accordance with claim 33. Preferred embodiments of this invention are listed in the dependent claims.

A method according to the invention for the optimisation and/or operation of at least one production process that is performed by at least one production machine in a production plant for the manufacture of at least one product, wherein the production plant has at least one operator interface for the input of setting values for at least one setting quantity—wherein preferably at least one system configuration value of at least one system configuration quantity is present in a memory unit—and—wherein in particular at least one setting value and/or at least one system configuration value is represented by a classified value—, comprises the following steps:
(a) recording of
   at least one setting value of at least one setting quantity and/or
   at least one value of a process quantity and/or at least one value of at least one reference quantity of the at least one production process obtained from at least one value of a process quantity
   by a data recording unit, wherein the values mentioned in this step are preferably represented in the form of classified values,
(b) establishing of
   at least one calculated setting value and/or
   at least one electronic message, in particular in the form of at least one recommended action
   by a computing unit by means of at least one set of rules, wherein the input data of the set of rules comprises the values recorded in step (a) and/or at least one system configuration value of at least one system configuration quantity and/or classified values of the said values,
(c) deciding whether
   the at least the one calculated setting value from step (b) should be adopted and/or
   the at least the one recommended action from step (b) should be followed
   by a decision-making unit and/or the operator via the at least one operator interface.

According to the invention it is provided that at least one set of rules from step (b) is established by a learning unit by means of at least one machine learning process using training data from a large number of production plants and/or a large number of production machines.

This means that—among other things—recommended actions, parameter settings, setting proposals for a production plant and/or machine etc. can be learned by means of data from a large number of production machines and can be directly provided to an operator interface and/or production plant and/or machine.

By a large number of production plants and/or production machines' it is referred to at least two, preferably, however, to more than 100 and even more preferably to more than 1000 production plants and/or production machines.

It can be provided that the training data comprises the following values for establishing the at least one set of rules:
at least one setting value of at least one setting quantity and/or
at least one value of at least one process quantity and/or
at least one value of at least one reference quantity and/or
at least one system configuration value of at least one system configuration quantity and/or
at least one classification of the afore-mentioned values and/or
at least one identifier of at least one of the afore-mentioned quantities and/or classes.

The identifier of a quantity or a class is a number and/or a string that is unambiguously assigned to that quantity or class respectively.

In one embodiment it is provided that at least one value of at least one control quantity is recorded and that from this value by means of the set of rules at least one value of at least one reference quantity is established, in particular a monitoring limit, and/or an electronic message, in particular a recommended action.

In one embodiment it is provided that at least one value of at least one system configuration quantity, that for example specifies the material of the product is, is used as an input value for the set of rules in order to establish at least one value of at least one control quantity and/or at least one value of at least one reference quantity and/or at least one electronic message via the set of rules.

In one embodiment it is provided that if not all the values of the setting quantities needed for starting the production process have been defined, at least one missing value is established as calculated value of a setting quantity in step (b).

In one embodiment it is provided that at least one value of at least one reference quantity of at least one process quantity from at least one production process is recorded, and that the values of setting quantities are continuously optimised.

In one embodiment it is provided that the values of the reference quantities in step (a) originate from the production process that is configured in accordance with the setting values in step (a), and in this case in particular, the production process is running immediately before step (a) as an intermediate step for a defined period of time and/or a defined number of cycles.

In one embodiment it is provided that, at least in case of a decision by the operator at the at least one operator interface in step (c), the at least one calculated setting value, preferably its classification as well, and/or the at least one electronic message from step (b), is displayed.

In one embodiment it is provided that in case of a positive decision by the decision-making unit and/or the operator
the at least one calculated setting value is adopted and/or the recommended action is performed and/or in case of a negative decision by the decision-making unit and/or the operator
the at least one old setting value is retained and/or
at least one new setting value is entered by the decision-making unit and/or by the operator at the at least one operator interface.

In one embodiment it is provided that in case of a change of the at least one setting value by the decision-making unit, a reason for this at the at least one operator interface in the form of an electronic message is displayed.

In one embodiment it is provided that the setting quantities of the at least one production process comprise control quantities of process quantities and/or monitoring limits of process quantities and/or quantities that define the type of monitoring.

In one embodiment it is provided that the system configuration quantities comprise quantities that describe characteristics of
the production plant,
at least one production machine, in particular a tool of at least one production machine,
the material of the product and/or
the customer.

For example, a system configuration quantity can be the region of the location of a production plant and/or the branch of the customer.

In one embodiment it is provided that the following units are connected or connectable to each other via a data connection by means of a computer network:
at least one production machine
at least one operator interface
the data recording unit
the decision-making unit
the computing unit
the learning unit
the production plant and at least one other production plant

In one embodiment it is provided that the production plant has a connection device that is connected or connectable to the computer network by means of data transmission, wherein the computer network, in particular comprises an internal computer network that is arranged inside the production plant, and an external computer network that is arranged outside the production plant, wherein the external computer network in particular connects the production plant to at least one further production plant. The connection device can be configured as an ‘edge device’.

In one embodiment it is provided that the data recording unit permanently or temporarily stores the data transmitted to it in the production plant, in the production machine and/or in the computer network.

In one embodiment it is provided that the learning unit carries out the at least one machine learning process on the at least one external computer network, with the external computer network being connected or connectable via a data connection with a large number of production plants.

In one embodiment it is provided that the learning unit carries out the at least one machine learning process on the at least one connection device, with the connection device being connected or connectable via data connection with a large number of production machines by means of the internal computer network.

In one embodiment it is provided that the training data of the learning unit is collected by a large number of production machines in at least one production plant, wherein the production machines are partly of a different type.

In one embodiment it is provided that the learning unit establishes at least one set of rules for a pre-defined problem, wherein preferably at least one supervised machine learning process is used, wherein the machine-learning process learns especially preferably from training data comprising answers assigned to the pre-defined problem.

In that respect, the training data can be available in various data structures, for example as a table and/or as a database and/or as a list.

The specific assignment of the answers to input data regarding a pre-defined problem can be achieved for example by arranging the training data in a data structure, for example a table with lines and columns.

In one embodiment it is provided that the learning unit can transfer at least one set of rules for a first pre-defined problem to a second pre-defined problem, in particular by training a set of rules that is pre-trained by the training data of a first pre-defined problem by training data of the second pre-defined problem during the machine learning process. In the literature one term for that would be ‘Transfer Learning’.

In one embodiment it is provided that at least one set of rules is established for at least one instance of a system configuration class, wherein that at least one set of rules is in particular trained for a pre-defined problem specific to that at the least one instance of the system configuration class.

In one embodiment it is provided that the learning unit establishes at least one set of rules without a pre-defined problem, wherein preferably at least one unsupervised machine-learning process is used.

In one embodiment it is provided that the machine-learning process employs one of the following methods:
decision tree
neural networks
lookup-table
formal relation
dynamic models (stochastic or model-based)

With the ‘lookup-table’ method, the training data can be filled into a table and saved. This data can then be retrieved as a set of rules.

The ‘formal relation’ method refers for example to the calculation of a statistical quantity, such as a median or a mean value, from data derived from a large number of production plants and/or production machines.

The ‘dynamic models’ method can refer to the use of a—preferably physical—model. Here for example, the model parameters of a defined model can be learned and/or an appropriate model can be selected by learning. In addition, qualitative characteristics of the model can be learned auto-didactically.

In one embodiment it is provided that the set of rules is stored in the production plant, in the production machine, in the connection device and/or in the computer network.

In one embodiment it is provided that the classification of at least one value is performed by a classification and assessment unit before step (a), wherein the classification and assessment unit performs in particular the following tasks:
assessment of data quality and disposal of irrelevant data, in particular recognition of anomalies
compaction and compression of data
creation of meta data

In one embodiment it is provided that the classification and assessment unit comprises at least one set of classification rules that was established in particular manually by means of expert knowledge and/or by a second learning unit having at least one characteristic of the learning unit from at least one of the preceding embodiments.

In one embodiment it is provided that the set of classification rules is stored in the production plant, in the production machine, in the connection device and/or in the computer network.

A feedback method according to the invention using the method, wherein the method is performed by using the at least one set of rules, and is characterised in that response values of at least one response quantity are collected by the data recording unit, with such response values being used as training data by the learning unit, thereby training at least one set of feedback rules, wherein the set of feedback rules is in particular used to assess and/or to further develop the method, in particular the set of rules.

In one embodiment of the feedback method, it is provided that the at least one response quantity describes the behaviour of the operator, for example the frequency of acceptance of a recommended action by the operator.

In one embodiment of the feedback method, it is provided that via the at least one operator interface the operator is asked questions, in particular in relation to an assessment of the method, wherein the relevant input from the operator relating to said questions constitutes at least one response quantity.

In one embodiment of the feedback method, it is provided that the at least one response quantity describes the response characteristics of the set of rules and/or the method, for example the sensitivity of the output values of said set of rules in response to a small change of the input values of said set of rules.

A production plant according to the invention features means that are appropriate for performing the method and/or the feedback method.

A computer program product according to the invention comprises commands that cause the production plant to perform the method and/or the feedback method.

It should be noted that the method is suitable for cycle-based and continuous production processes. In particular, the method is therefore suitable for performing in production plants that contain at least one injection moulding machine and/or at least one plastic extruder.

Sending the data which is necessary due to the use of data of a large number of production machines and/or production plants can be carried out in an anonymised or in a not anonymised way.

A production plant has at least one production machine. The at least one production machine can have at least one peripheral device that is also part of the production plant. Furthermore, at least one operator interface is provided in the production plant. Controlling and monitoring can be performed in a centralized manner, e.g. by a Manufacturing Execution System (MES).

Setting quantities are defined by the operator or by a computer program, for example the method according to the invention for the optimisation and/or operation of a production process and/or a control algorithm.

Examples of setting quantities of the production process are in particular control quantities and/or reference quantities. By way of example, control quantities can be command quantities the momentary values of which correspond to target values, or quantities that define the type of controlling. Furthermore, in this case it might be referred to setting quantities for control algorithms of the production process. Reference quantities can for example be monitoring limits for a process quantity or quantities that define the type of monitoring.

Examples of setting quantities of a method or computer program, for example of the method according to the invention for the optimisation and/or operation of a production process, are quantities that define which set of rules is to be used. In this case, it might also be referred to setting quantities of an expert system or a control algorithm of a production machine.

By way of example, response quantities describe the behaviour of a production process, a method or an operator. Used as describing quantities, the response quantities are not defined or set quantities.

Process quantities are physical measuring quantities or quantities of the production process derived therefrom. Process quantities describe the behaviour of the production process and are therefore response quantities.

Indirect process quantities or identification numbers are quantities derived from one or more process quantities. By way of example, indirect process quantities or identification numbers can describe the characteristics of a measuring curve for a process quantity, or can be instants of time at which process quantities have defined values, or can be for example the standard deviation of several past values for a process quantity. Indirect process quantities and identification numbers are, too, response quantities.

Process quantities and/or indirect process quantities can comprise quality quantities, such as. weight, dimensional accuracy, warpage and/or surface, in particular of components of the production machine and/or the production plant. These quantities can be measured directly and/or derived from process quantities.

The response quantities of the operator record the behaviour of the operator. One example is the relative frequency of acceptance of a recommended action by the operator.

The response quantities of a method, such as the method according to the invention for the optimisation and/or operation of a production process, can for example describe the behaviour of a set of rules. In that respect it is, for example, possible to record how sensitively the output values of the set of rules respond to a small change of the input values of said set of rules.

System configuration quantities are describing quantities and are independent from setting quantities and response quantities. By way of example, they describe characteristics of the material, the production machine, the customer, the tool or the geographic location. By way of example, the type of machine can be a characteristic of the production machine and the branch in which the customer is active can be a characteristic of the customer.

Accordingly, the system configuration quantities only change when the configuration is changed, e.g. the tool, customer, production machine or similar, and in particular these quantities do not change during and/or as a result of the steps (a), (b) and (c) of the method according to the invention or by a production process.

By way of example, a parameter class can summarise process quantities with the same unit, from the same section of the production process and/or from the same area or component of the production machine.

By way of example, a system configuration class can summarise the types of production machines, the geographical regions of the location of a production machine or production plant, or also the branch in which the customer is active.

According to the terminology, the quantities described can be categorised in the present application, for example, as follows:

setting quantity
setting quantity of the production process
   control quantity
   reference quantity
setting quantity of a method/computer program
   control quantity for the computing unit/the method

response quantity
response quantity of the production process
   process quantity
   indirect process quantity or identification number
response quantity of a method/computer program
response quantity of the operator

system configuration quantity
referring to the production plant
referring to the customer

Embodiments of the invention are discussed on the basis of the Figures. In that respect

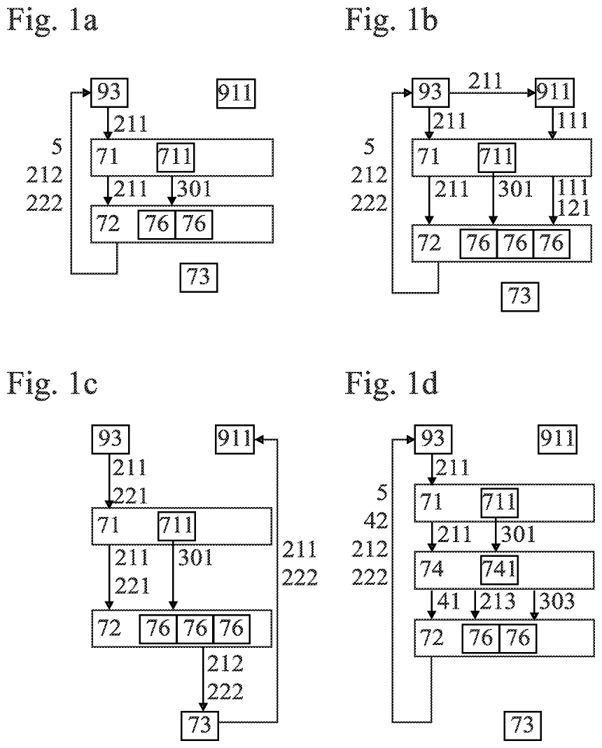

FIG. 1a-d show embodiments of the method according to the invention

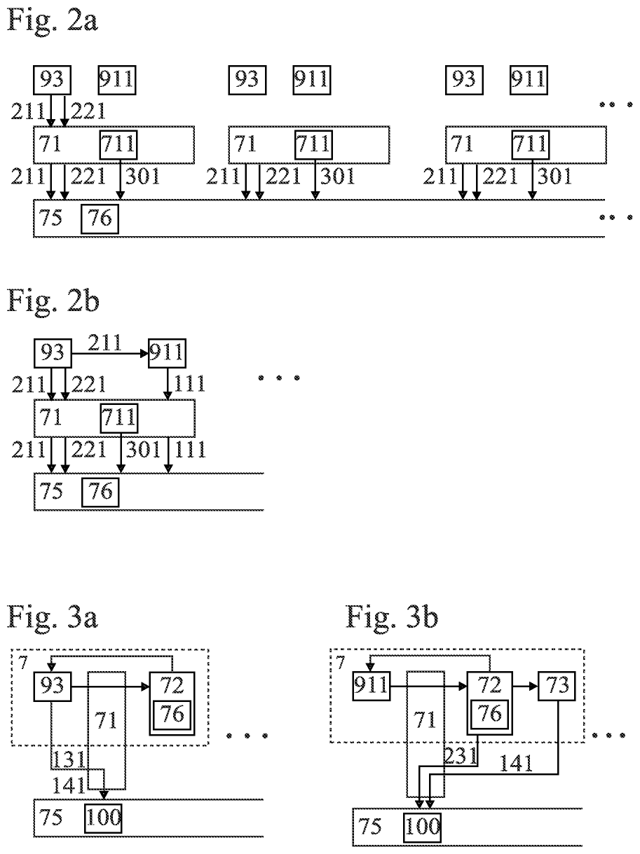

FIG. 2a, b show training a set of rules by the learning unit

FIG. 3a,b show a feedback method, a. user feedback, b. assessment of the method

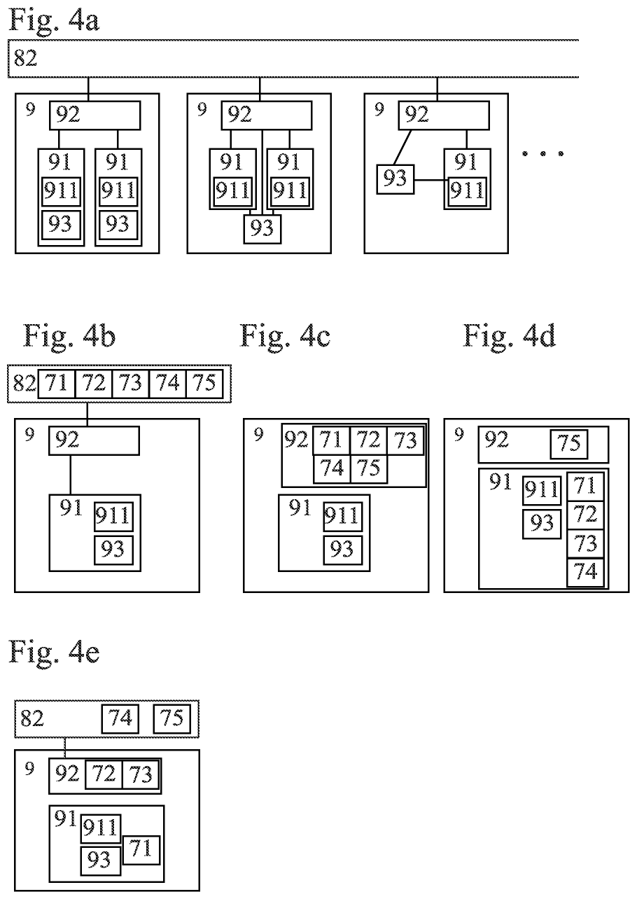

FIG. 4a-e show a network architecture and arrangement of the computing units

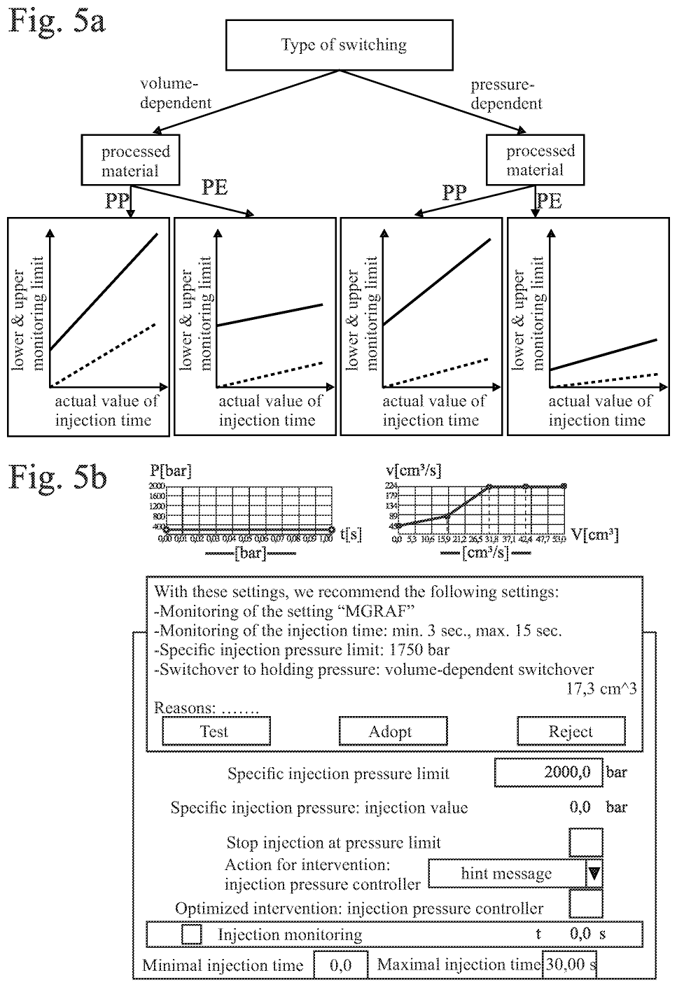

FIG. 5a, b show a specific embodiment with a set of rules in the form of a decision tree

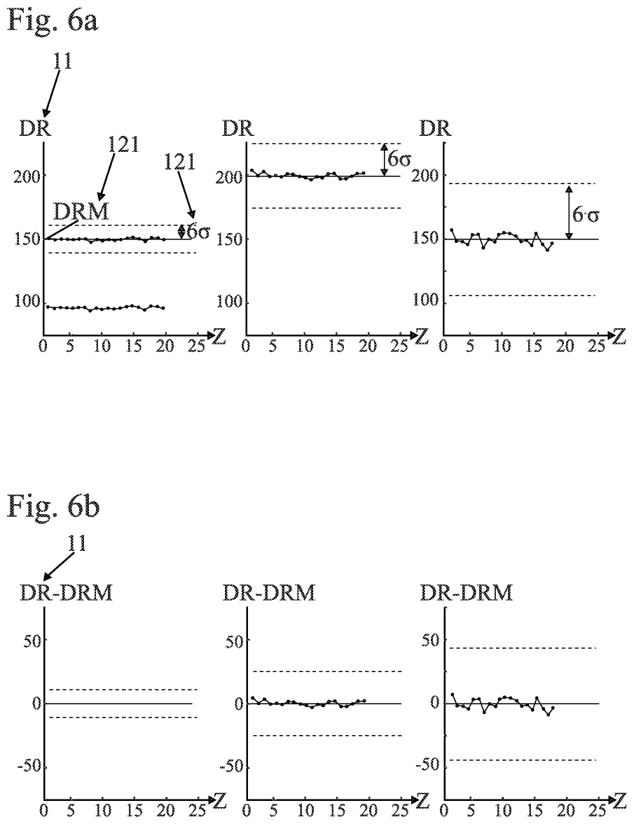

FIG. 6a, b show an averaging of monitoring limits for several injection moulding machines

FIG. 1a-d show embodiments of the method according to the invention 7 for the optimisation and/or operation of a production process 911. In that respect FIG. 1a illustrates an embodiment in which recommended actions based on the values of setting quantities 2 entered by the operator are to be displayed at the at least one operator interface 93. Here, the operator has entered in particular at least one value 211 for a control quantity 21 to control the production process 911. This at least one value 211 is recorded by the data recording unit 71 and cached. The at least one value 211 is transmitted to the computing unit 72. In the computing unit 72 several, in this case two in particular, sets of rules 76 are stored. The two sets of rules 76 respectively calculate different output data from the at least one value 211 of a control quantity 21. The output data of the sets of rules 76 include at least one calculated value 212 of a control quantity 21 for controlling the production process 911 and at least one calculated value 222 of a reference quantity 22 for monitoring the production process 911. In that respect for example, the at least one calculated value 212 from the first set of rules 76 and the at least one calculated value 222 from the second set of rules 76 can be established. The calculated values are then sent to the at least one operator interface 93 and visualised for the operator, for example, in the form of an electronic message 5. Alternatively, or in addition, an electronic message 5 can be sent as an output value of a set of rules to the at least one operator interface, for example to issue warnings or to present the at least one value 212 and/or 222 that was sent along to the operator in a user-friendly way.

Furthermore, at least one system configuration value 301 of a system configuration quantity 3 can be saved in a memory unit 711 in the data recording unit 71, This value can also be used as an input value for the sets of rules 76.

Returning an electronic message 5 to the at least one operator interface 93 can for example be used to warn the operator of poor settings that can jeopardise the quality of the product or even constitute a risk to the production machine 91. Moreover, the return of at least one calculated value 212 of a control quantity 21 to the at least one operator interface 93 can be used for specific recommended actions 51 for changing the set values of control quantities 21 to improved values, by way of example the at least one calculated value 212.

If, for example, a quantity of material and a cooling time are set on an injection moulding machine, the set of rules 76 can tell that the cooling time is too short in relation to the quantity of material and that therefore quality problems regarding the product, such as local sink marks and warpage are to be expected. The operator then receives a recommended action 51, and is in particular recommended by an electronic message 5 to accordingly extend the setting for the cooling time, wherein a specific value or a range of values for the cooling time can also be displayed.

Furthermore, the return of at least one calculated value 212 of a control quantity 21 and/or a calculated value 222 of a reference quantity 22 to the at least one operator interface 93 can be used to propose at least one value 212 and/or 222 of control quantities 21 and reference quantities 22 that have not yet been set. In that respect, the method 7 acts as a setting assistant.

For example, if an operator uses a specific material that is saved by means of a system configuration value 301 of a system configuration quantity 3 assigned to that material, missing setting values, e.g. at least one value 212 of a control quantity 21 and/or at least one value 222 of a reference quantity 22, can be proposed automatically by the set of rules 76.

Returning at least one calculated value 222 of a reference quantity 22 that is assigned to a process quantity 11 of the production process 911 to the at least one operator interface 93 can for example be used to propose monitoring limits of the process quantity 11 to the operator.

For example, the operator can set a target injection profile as a control quantity 21 at the at least one operator interface 93 with said profile then being forwarded to the computing unit 72 by the data recording unit 71. Then, a set of rules 76 calculates the monitoring limits of a process quantity 11 of the moulding process 911 from this target injection profile, wherein the monitoring limit values 222 represent a reference quantity 22 assigned to the process quantity 11. Then, the recommended action 51 in the form of an electronic message 5 with the exemplary content, ‘Customers who have set a similar injection profile set the following monitoring limits for the process quantity on the micrograph’ together with a list of the calculated values 222 of the reference quantity 22 can appear on the at least one operator interface. The operator then accepts, rejects or corrects the values on the basis of the recommended action 51.

FIG. 1b shows an alternative embodiment of the method according to the invention, wherein in this case, for data acquisition purposes, one or more cycles of the production process 911 (or a continuous production process 911 for a certain period of time) are performed on the basis of the values 211 of the control quantities 21 defined in the at least one operator interface 93. By way of example, the cycles can be considered as test cycles before the start of the mass production (or the time period can be considered as a test run). Next, by way of example, the values 211 of control quantities 21 of the at least one operator interface 93 and the values 111 of the process quantities 11 assigned to the control quantities 21 of the production process 911 are collected by the data recording unit 71. The values together with the system configuration values 301 are then transmitted to the computing unit 72 which solves various problems by means of—in this case—three sets of rules 76.

By way of example, from the ratios between target and actual values, proposals for optimising the production process 911 and/or for a control algorithm of the production process 911 can be displayed on the at least one operator interface 93, in particular together with a user-friendly dialogue consisting of text messages 5.

Furthermore, at least one indirect process value 121 of an indirect process quantity 12, e.g. a measure of dispersion of the values 111 of the process quantity 11, can be established from several values 111 of at least one process quantity 11 (also see FIG. 1b). A scaled measure of dispersion of the values 111 of the process quantity 11 can be used as an adaptive monitoring limit for a process quantity 11 in the production process 911. In that respect, it can be an advantage to conduct another check on the provisional monitoring limits resulting from the scaled measure of dispersion. This check and, where necessary, an adjustment of values can be performed by the computing unit 72 using a set of rules 76 created for this purpose. The computing unit 72 then sends the adapted monitoring limits (as calculated reference values 222) back to at least one operator interface 93 and/or directly back to the production process 911 (not shown in FIG. 1b).

FIG. 1c shows an embodiment of the method according to the invention for direct parameterisation of the production process 911 or of a control algorithm of the production process 911 through calculated values 212 of control quantities 21 or of the monitoring of the production process 911 through calculated values 222 of reference quantities 22.

An incomplete set of values of setting quantities 2, in this case control and reference values 211, 221, is entered by the operator at the at least one operator interface 93. The control and reference values 211, 221 and the system configuration values 301 are forwarded to the computing unit 72 by means of the data recording unit 71. Now, the calculated control and reference values 212, 222 represent a complete set of values of setting quantities 2 that is suitable for parameterizing the production process 911 or a control algorithm of the production process 911. Instead of sending the output data of the sets of rules 76 back to the at least one operator interface 93, a decision-making unit 73 can decide on the basis of the calculated control and reference values 212, 222 whether the values will or will not be transmitted to the production process 911. Furthermore, the values of a complete setting record of the production process 911 or of a control algorithm of the production process 911 can be improved by the optimisation method 7, for example by comparing target and actual values of process quantities 11, as shown in FIG. 1b.

FIG. 1d shows a variation of the embodiment in FIG. 1a with a classification and assessment unit 74 being interposed between the data recording unit 71 and the computing unit 72. This unit classifies, assesses and selects data using a set of classification rules 741. By this, the unit forwards selected values 213, 303 and instances 41 of classes 4 to computing unit 72. The computing unit 72 contains sets of rules 76 that process these values and instances of classes as input data and ejects calculated values 212, 222, calculated instances 42 of classes 4 and, if need be, electronic messages 5 that are sent back to the at least one operator interface 93.

In this case it is to be noted that even without the classification and assessment unit 74 in the optimisation cycle 7, classified values can be used and can be understood by the set of rules 76. In this case, the classification took place before the method 7 has been performed, manually by the operator, automatically by another classification unit and/or already in-factory.

FIG. 2a, b show embodiments of the training of a set of rules 76 by a learning unit 75. FIG. 2a shows a set of rules 76 that learns missing setting values 202 of a production process 911 from existing setting values 201 through a large number of settings made by different operators. With a set of rules 76 trained that way, it is for example possible to establish reference values 222 for monitoring limits from the values 211 of control quantities 21 entered by the operator, as shown in FIG. 1a. To train the set of rules 76, control values 211 and reference values 221 are entered by at least one operator at several operator interfaces 91 of several production machines 91. These are forwarded via the respective data recording unit 71 assigned to the production machine 91 to the shared learning unit 75. In addition, every production machine 91 sends system configuration values 301 to the learning unit 75. To generate the set of rules, for example a table is created that contains pairs of control values 211 and reference values 221 with one pair coming from a production machine 91. This table can be used as a lookup table and can already form the set of rules 76. In addition, the table can function as the training data record of a supervised machine learning process, e.g. for training a neural network. A set of rules 76 trained that way can establish a reference value 222 through a query by means of a control value 221, and this way the set of rules 76 can for example establish appropriate monitoring limits by means of an injection curve. In this case, the problem of the set of rules 76 is specified by assigning training data pairs, i.e. by the table.

FIG. 2b shows the training of a set of rules 76 for another problem, in particular for the detection of ‘poor’ setting values, as in FIG. 1a. In this case, a set of control values 211 is used to control a production process 911. The control values 211 and the values of process quantities 111 are forwarded to learning unit 75, optionally also together with system configuration values 301. The training of a set of rules 76 with such a data record comprising control values 211 and process values 111 enables the trained set of rules 76 to predict the course of a process. Furthermore, if exceedings of reference values 221 are taken into account, the set of rules 76 is able to predict and assess the course of a process in operating conditions and can forward warnings and proposals regarding the change of value to the at least one operator interface 93.

FIG. 3a, b show a schematic diagram of the feedback method for the method 7. In that respect, FIG. 3a shows the training of a set of feedback rules 100 through operator feedback and/or operator behaviour. In this case, the operator can evaluate, for example, the behaviour of an already completed method 7 at the at least one operator interface 93 by means of the response quantities 14 of the method 7. The values 141 of the response quantities 14 of the method 7 can then train a set of feedback rules 100 in the learning unit 75. The set of feedback rules 100 can be used to assess and/or to further develop the set of rules 76. Furthermore, the operator behaviour can be automatically recorded when operating the production machine 91, the production plant 9 and/or the method 7 by means of the operator response quantities 13 and can be forwarded to the learning unit 75 for training the set of feedback rules 100.

FIG. 3b shows the training of a set of feedback rules 100 by observing the behaviour of the method 7 for the automatic parameterisation of a production process 911. Typically, the method 7 has a set of rules 76 that differs from the feedback rules 100 in the learning unit 75. However, the set of feedback rules 100 can be based on the set of rules 76 of the method 7 and can be trained for further development. The behaviour of the method 7 is described by the response quantities 14 the values 141 of which are transmitted to the learning unit 75. Such a response quantity 14 can for example indicate how sensitively the output values of the set of rules 76 respond to a small change of the input values of the set of rules 76.

Furthermore, control values 231 from the computing unit 72 can be directed to the learning unit 75. Accordingly, in trained condition the set of feedback rules 100 can, for example, draw conclusions from control values 231 of a set of rules 76 as regards a future behaviour of the set of rules 76.

FIG. 4a-e show the locations of the devices and units. FIG. 4a shows the network architecture that has several production plants 9 connected by an external computer network 82. Connecting an internal computer network 81 to the external computer network 82 is achieved by using a connection device 92. In the internal computer network 81 of a production plant 9, the production machines 91 are located that can perform a production process 911 and have at least one operator interface 93. The at least one operator interface 93 can also be embedded in the internal computer network 81 separate from the production machine 91, for example in the form of a tablet or smartphone. Furthermore, all production machines 91 in of production plant 9 can also be controlled and monitored by a Manufacturing Execution System.

FIG. 4b-e show various possible locations of the units of the method 7 in the computer network 8. To keep this illustration simple, in this case only one production plant 9 is shown. FIG. 4b shows the data recording unit 71, the computing unit 72, the decision-making unit 73, the classification and assessment unit 74 and the learning unit 75 in the external computer network 82. Nevertheless, all units but the learning unit 75 preferably process data exclusively from one production machine 91. In FIG. 4c, all the afore-mentioned units are arranged in the connection device 92. In FIG. 4d, all units but the learning unit 75 are arranged directly at the production machine 91. The learning unit 75, however, is arranged in the connection device 92. FIG. 4e shows an arrangement in which the learning unit 75 and the assessment and classification unit 74 are embedded in the external computer network 82, while the computing unit 72 and the decision-making unit 73 are arranged in the connection device 92. In this case, the data recording unit 71 is arranged directly at the production machine 91.

It is to be noted that the units of the method 7 and the learning method shown in FIG. 4b-e can be arranged in any order. In particular, a unit can be arranged in the external computer network 82 and in the internal computer network 81 at same time. In this context, ‘unit’ is preferably considered as a logical unit which however does not exclude this referring to a physical unit.

FIG. 5a, b illustrates a specific embodiment for an injection moulding process. In the data recording unit 71, the following data are recorded cyclically.
process quantities 11:
   actual values of the injection time
   injection curves
control quantities 21:
   target values of the process quantities 11
   switch criteria
reference quantities 22:
   minimum and maximum values for the prevailing injection time.
system configuration quantities 3:
   type of material

This data is transferred to the connection device 92 or to the external computer network 82. There, the data is categorized into the following classes 5 using the classification and assessment unit 74:
tool types
type of switching
processed types of material

In addition, the shape of the injection curves is assessed by the classification and assessment unit 74 in order to detect any anomalies in advance.

To learn the set of rules 76, raw data as well as the classified data is used by the learning unit 75. Learning takes place in the external computer network 82. The set of rules 76 resulting from this is the decision tree shown in FIG. 5a.

Before performing the method 7, the completed set of rules 76 is uploaded to the connection device 92 by the external computer network 82 where it is then available as an OPC/UA service or as a REST interface.

Through continuous learning, the set of rules 76 is continuously improved and, by means of updates it is uploaded continuously, at defined intervals and/or after any sufficiently large change of the learned set of rules 76 from the external computer network 82 to the connection device 92 which makes it available to the method 7.

The set of rules 76 in FIG. 5a, when used in the method 7, issues output data in the form of an upper and lower monitoring limit as a function of the actual value of the injection time. In FIG. 5a, the upper monitoring limit is shown as a continuous line and the lower monitoring limit is shown as a broken line. This function represents a reference quantity 22 for the intelligent monitoring of a production process 911, in this case an injection moulding processes. The input data of the set of rules 76 are the class 5 ‘type of switching’ with the instances 51 ‘volume-dependent’ and ‘pressure-dependent’ and the class 5 ‘processed material’ with the instances 51 ‘PP’ and ‘PE’. This calculation by the computing unit 72 takes place on connection device 92.

The outcome of at least one set of rules 76 is displayed as recommended action 51 at the at least one operator interface 93 in the form of a dialogue, as illustrated by the example in FIG. 5b (it is not the result of the decision tree of FIG. 5a which is shown here). The operator has the option of testing the recommended actions 51, or of adopting or rejecting them. In addition, based on the decision by the operator, an operator feedback dialogue can be displayed, wherein the operator can assess the tested settings and/or the recommended actions 51 himself. This operator feedback, as for example shown in FIG. 3a, can be directed to a set of feedback rules 100 which serves to improve the recommended actions 51 and/or to improve the set of rules 76, for example the decision tree in FIG. 5a.

FIG. 6a, b show examples of the value curve of torques DR (a process quantity 11) in Newton meter (Nm) units over several cycles Z when dosing three identical models of injection moulding machines that produce the same moulded part with the same material. In addition, FIG. 6a shows the mean value DRM and a scaled measure of dispersion, in this case six times the standard deviation a. The scaled measure of dispersion in this case has the values 10 Nm, 15 Nm and 45 Nm.

In contrast, FIG. 6b shows the value curve with an ordinate displaced by the respective mean value DRM. In addition, FIG. 6b shows the median of scaled measure of dispersions at 15 Nm.

The value curve of the process quantity 11 and/or the indirect process values 121 established thereof such as the scaled measure of dispersion can for example be used to train a set of rules 76 that shall check adaptive monitoring limits (as shown in FIG. 1b). However, typically values of a large number of injection moulding machines are used for that, in particular more than three. The median can be ‘learned’ from the scaled measure of dispersions of three (or typically a large number of) injection moulding machines.

In a method 7, this median can be proposed as a monitoring limit if an injection moulding machine of that kind and with that material is used. Alternatively, as shown in FIG. 1b, it is also possible to establish adaptive monitoring limits from the current production process 911, wherein these monitoring limits are checked during the method 7 by set of rules 76. It is for example possible to check whether the established adaptive monitoring limit is located within a defined and permitted range around the ‘learned’ median at 15 Nm, e.g. from 10 Nm to 20 Nm. Where necessary, the monitoring limit can be adapted to fit inside the permitted range.

### LIST OF REFERENCE SYMBOLS

1 Response quantity
101 Response value
11 Process quantity
111 Value of a process quantity
12 Indirect process quantity
121 Value of an indirect process quantity
13 Response quantity of the operator
131 Value of an operator-related response quantity
14 Response quantity of the method
141 Value of a response quantity of the method
2 Setting quantity
201 Setting value
202 Calculated setting value
21 Control quantity
211 Value of a control quantity
212 Calculated value of a control quantity
213 Selected value of a control quantity
22 Reference quantity
221 Value of a reference quantity
222 Calculated value of a reference quantity
223 Selected value of a reference quantity
23 Control quantity of the computing unit
231 Value of a control quantity of the computing unit
3 System configuration quantity
301 Value of a system configuration quantity
303 Selected value of a system configuration quantity
4 Class
41 Instance of a class
42 Calculated instance of a class
5 Electronic message
51 Recommended action
6 Form of data transmission
7 Method
71 Data recording unit
711 Memory unit
72 Computing unit
73 Decision-making unit
74 Classification and assessment unit
741 Set of Classification rules
75 Learning unit
76 Set of rules
8 Computer network
81 Internal computer network
82 External computer network
9 Production plant
91 Production machine
911 Production process
912 Control unit
92 Connection device
93 Operator interface
95 Memory unit
100 Set of feedback rules

1. A method for the optimisation and/or operation of at least one production process that is performed by at least one production machine in a production plant for the manufacture of at least one product, wherein the production plant has at least one operator interface for the input of setting values of at least one setting quantity—wherein preferably at least one system configuration value of at least one system configuration quantity is present in a memory unit—and—wherein in particular at least one setting value and/or at least one system configuration value is represented by at least one classified value—, and the method comprises the following steps:
(a) recording of
at least one setting value of at least one setting quantity and/or
at least one value of at least one process quantity and/or at least one value of at least one indirect process quantity of the at least one production process obtained from at least one value of a process quantity,
by a data recording unit, wherein the values mentioned in this step are preferably represented in the form of classified values,
(b) establishing of
at least one calculated setting value and/or
at least one electronic message, in particular in the form of at least one recommended action,
by a computing unit by means of at least one set of rules, wherein the input data of the set of rules comprises the values recorded in step (a) and/or at least one system configuration value of at least one system configuration quantity and/or classified values from said values,
(v) deciding whether
the at least the one calculated setting value from step should be adopted and/or
the at least the one recommended action from step (b) should be followed
by a decision-making unit and/or the operator via the at least one operator interface
wherein at least one set of rules from step (b) is created by a learning unit by means of at least one machine learning process employing training data from a large number of production plants and/or a large number of production machines.

2. The method in accordance with claim 1, wherein the training data used for creating the at least one set of rules comprise the following values:
at least one setting value of at least one setting quantity and/or
at least one value of at least one process quantity and/or
at least one value of at least one indirect process quantity and/or
at least one system configuration value of at least one system configuration quantity and/or
at least one classification of the aforementioned values and/or
at least one identifier of at least one of the aforementioned quantities and/or classes.

3. The method in accordance with claim 1, wherein at least one value of at least one control quantity is recorded and that from this value using the set of rules at least one value of at least one reference quantity, in particular a monitoring limit, and/or an electronic message, especially a recommended action, is established.

4. The method in accordance with claim 1, wherein at least one value and/or identifier of at least one system configuration quantity, that for example specifies the material of the product, is used as an input value for the set of rules in order to establish at least one value of at least one control quantity and/or at least one value of at least one reference quantity and/or at least one electronic message via the set of rules.

5. The method in accordance with claim 1, wherein, if not all the values of the setting quantities required for starting the production process have been defined, at least one missing value is established as calculated value of a setting quantity in step (b).

6. The method in accordance with claim 1, wherein at least one value of at least one indirect process quantity and/or process quantity is recorded by at least one production process and values of setting quantities are continuously optimised.

7. The method in accordance with claim 1, wherein the values of the indirect process quantities in step (a) originate from the production process that is configured in accordance with the setting values in step (a), and wherein in particular in this case the production process is running for a defined period of time and/or a defined number of cycles immediately before step (a) as an intermediate step.

8. The method in accordance with claim 1, wherein at least in case of a decision by the operator on the at least one operator interface in step (c), the at least one calculated setting value, preferably its classification as well, and/or the at least one electronic message from step (b) is displayed.

9. The method in accordance with claim 1, wherein in case of a positive decision by the decision-making unit and/or the operator
the at least one calculated setting value is adopted and/or the recommended action is performed
and/or in case of a negative decision by the decision-making unit and/or the operator
the at least one old setting value is retained and/or
at least one new setting value is entered by the decision-making unit and/or by the operator at the at least one operator interface.

10. The method in accordance with claim 9, wherein in case of a change of the at least one setting value by the decision-making unit, a reason for this is displayed on the least one operator interface in the form of an electronic message.

11. The method in accordance with claim 1, wherein the setting quantities of the at least one production process comprise control quantities of process quantities and/or monitoring limits and/or quantities that define the type of monitoring.

12. The method in accordance with claim 1, wherein the system configuration quantities comprise quantities that describe characteristics
of the production plant,
of the at least one production machine, in particular of a tool of at least one production machine,
the product material and/or
the customer.

13. The method in accordance with claim 1, wherein the following units are connected or connectable to each other via a data connection by means of a computer network:
at least one production machine
at least one operator interface
the data recording unit
the decision-making unit
the computing unit
the learning unit
the production plant and at least one further production plant.

14. The method in accordance with claim 13, wherein the production plant has a connection device that is connected or connectable to the computer network, by means of data transmission, wherein the computer network comprises in particular an internal computer network that is arranged inside the production plant, and an external computer network that is arranged outside the production plant, wherein the external computer network connects in particular the production plant to at least one further production plant.

15. The method in accordance with claim 13, wherein the data recording unit stores the data sent to it permanently or temporarily in the production plant, in the production machine and/or in the computer network.

16. The method in accordance with claim 14, wherein the learning unit carries out the at least one machine learning process on the at least one external computer network, to which external computer network a large number of production plants are connected or connectable via a data connection.

17. The method in accordance with claim 14, wherein the learning unit carries out the at least one machine learning process on the at least one connection device, with which connection device a large number of production machines are connected or connectable via a data connection by means of the internal computer network.

18. The method in accordance with claim 1, wherein the training data of the learning unit is collected by a large number of production machines in at least one production plant, where some of those production machines are of a different type.

19. The method in accordance with claim 1, wherein the learning unit establishes at least one set of rules for a pre-defined problem, wherein preferably at least one supervised machine learning process is used, wherein the machine learning process learns especially preferably from training data comprising answers assigned to the pre-defined problem.

20. The method in accordance with claim 19, wherein the learning unit can transfer at least one set of rules for a first pre-defined problem to a second pre-defined problem, in particular by training a set of rules which is pre-trained for a first pre-defined problem with training data of the second pre-defined problem when using the machine learning process.

21. The method in accordance with claim 1, wherein at least one set of rules is created for at least one instance of a system configuration class, wherein this at least one set of rules is in particular trained for a pre-defined problem which is specific to the at least one instance of the system configuration class.

22. The method in accordance with claim 1, wherein the learning unit establishes at least one set of rules without a pre-defined problem, wherein preferably at least one unsupervised machine learning process is used.

23. The method in accordance with claim 22, wherein the machine learning process employs one of the following methods:
decision tree
neural network
lookup-table
formal relation
dynamic models (stochastic or model-based)

24. The method in accordance with claim 14, wherein the set of rules is saved in the production plant, in the production machine, in the connection device and/or in the computer network.

25. The method in accordance with claim 1, wherein the classification of at least one value is performed by a classification and assessment unit before step (a), wherein the classification and assessment unit performs in particular the following tasks:
assessment of data quality and disposal of irrelevant data, in particular recognition of anomalies and/or runaway values
compaction and compression of data
creation of meta data

26. The method in accordance with claim 25, wherein the classification and assessment unit comprises at least one set of classification rules, that was in particular created manually by means of expert knowledge and/or by a second learning unit comprising at least one characteristic of the learning unit.

27. The method in accordance with claim 26, wherein the set of classification rules is saved in the production plant, on the production machine, on the connection device and/or in the computer network.

28. A feedback method employing the method in accordance with claim 1, wherein the method is performed by using the at least one set of rules, wherein response values of at least one response quantity are collected by the data recording unit, wherein the response values are used as training data by the learning unit, thereby training at least one set of feedback rules wherein the at least one set of feedback rules is in particular used to assess and/or to further develop the method, in particular the at least one set of rules.

29. The feedback method in accordance with claim 28, wherein at least one response quantity describes the behaviour of the operator, for example the frequency of acceptance of a recommended action by the operator.

30. The feedback method in accordance with claim 28, wherein via the at least one operator interface the operator is asked questions, in particular in relation to an assessment of the method, wherein the input from the operator relating to said questions constitutes at least one response quantity.

31. The feedback method in accordance with claim 28, wherein the at least one response quantity describes the response characteristics of the set of rules and/or the method, for example the sensitivity of the output values of said set of rules in response to a small change of the input values of said set of rules.

32. A production plant with appropriate means for performing the feedback method in accordance with claim 28.

33. A computer program product comprising commands that cause a production plant to operate the method in accordance with claim 1.
